(19) United States
(12) Patent Application Publication
(10) Pub. No.: US 2025/0031639 A1
(43) Pub. Date: Jan. 30, 2025

(54) METHOD FOR SCREENING TOBACCO RESISTANCE AGAINST ROOT-KNOT NEMATODE BASED ON INTENSIVE SEEDLING PRODUCTION

(71) Applicant: Yunnan Academy Of Tobacco Agricultural Sciences, Kunming (CN)

(72) Inventors: Dunhuang FANG, Kunming (CN); Bingguang XIAO, Kunming (CN); Zhiyu FENG, Kunming (CN); Zhijun TONG, Kunming (CN); Dahai YANG, Kunming (CN); Yahui WANG, Kunming (CN); Xingfu WU, Kunming (CN); Jianmin ZENG, Kunming (CN); Xuejun CHEN, Kunming (CN)

(73) Assignee: Yunnan Academy Of Tobacco Agricultural Sciences, Kunming (CN)

(21) Appl. No.: 18/398,237

(22) Filed: Dec. 28, 2023

(30) Foreign Application Priority Data
Jul. 24, 2023 (CN) 2023109111691

(51) Int. Cl. A01G 7/06; A01G 31/00

(52) U.S. Cl. CPC A01G 31/00

(57) ABSTRACT

A method for screening tobacco resistance against root-knot nematode based on intensive seedling production is provided. The method has two biological properties: inducing and stimulating the hatching of nematode eggs by host root exudates, and easily infecting the root cap elongation zone by hatched second-instar larvae. The second-instar larvae hatched by the root-knot nematode eggs are continuously inoculated. After that, under cultivating the infected tobacco seedlings in shallow water infiltrating and humidifying substrate, the created temperature, humidity and air permeability conditions are suitable for disease induction. After disease investigation, disease index is calculated, and the resistance of tested cultivars is evaluated according to the disease index. The method features simple operation, high selection efficiency, and high accuracy and reproducibility.

### CROSS REFERENCE TO THE RELATED APPLICATIONS

This application is based upon and claims priority to Chinese Patent Application No. 2023109111691, filed on Jul. 24, 2023, the entire contents of which are incorporated herein by reference.

### TECHNICAL FIELD

The present disclosure relates to the technical field of breeding tobacco for disease resistance, and in particular to a method for screening tobacco resistance against root-knot nematode based on intensive seedling production.

### BACKGROUND

Tobacco root-knot nematode (Meloidogyne spp.) is one of the important diseases of tobacco (Nicotiana spp.). Tobacco grows slowly after infection, and the apex and margin of the base and lower leaves turn from green to yellow, gradually inner curling and shriveling. When pulling up the plant roots, it can be found that the roots are hideously deformed, the lesion is claw-shaped, and the distribution of diameter is uneven. In severe cases, the root rots and the whole plant withers, causing great losses to tobacco production. Not only can root-knot nematodes cause damages to tobacco directly, but also other diseases such as tobacco black shank and bacterial wilt are aggravated subsequently, resulting in an annual loss of tobacco output value of about USD 400 million. The breeding and promoting of disease-resistant cultivars is the most economical and effective method to control diseases, and the identification of germplasm resources with disease resistance is foundation of breeding for disease resistance.

At present, resistance evaluation of Nicotiana spp germplasm to root-knot nematodes has mainly two methods. The first inoculation identification method uses diseased soil, in which tobacco plants are grown in diseased fields, or cultivated in the pots containing diseased soil/soil inoculated with nematode eggs. After 60 days, the plant is pulled up to investigate the disease, and the disease index is calculated to evaluate the resistance level of the plant. This method chooses and uses the natural infection conditions in the field, which does not require the preparation of a large number of the second-instar larvae e. But the disadvantage is obvious that the second-instar larva and egg pods in the diseased soil or the eggs hatching the second-instar larvae are not accurately quantified, and the accuracy of evaluating plant resistance cannot be guaranteed because of many factors influencing the identification process. The second method is to use second-instar larvae inoculation. The second-instar larvae are inoculated into the disinfected soil or substrate, and the plants to be tested are transplanted. After 60 days, the incidence is investigated This method requires a large number of second-instar larvae and disinfecting a lot of soil or substrate, which is labor intensive and time-consuming. These two methods are not conducive to expanding the scale, due to the heavy workload, large space occupation, and longer period of resistance disease identification. Therefore, it is necessary to develop a novel identification method for resistance identification of tobacco root-knot nematode with a shorter cycle, stable results, and easy scale application.

### SUMMARY

The present disclosure aims to provide a method for screening tobacco resistance against root-knot nematode based on intensive seedling production. The method features simple and convenient operation, a shorter identification period, and high accuracy and reproducibility.

The examples of the present disclosure are achieved as follows:

A method for screening tobacco resistance against root-knot nematode based on intensive seedling production is provided, including the steps:

Sowing the test tobacco seeds and performing seedling cultivation in a float system until fibrous roots penetrate out of the float tray into the float pool to obtain fibrous root seedlings;

Taking out the seedlings with substrate from the float tray and transplanting them into a larger hole float tray without substrate, dropping suspension of root-knot nematode eggs onto the fibrous roots protruding substrate surface, then immersing the distal parts of the fibrous roots into the water and hatching the root-knot nematode eggs in the water film on the surface of the fibrous roots to produce second-instar larvae; and

Cultivating the infected tobacco seedlings in shallow water infiltrating and humidifying substrate, inducing the disease by simulating the most suitable climatic environment for the root-knot nematode, and evaluating the disease severity.

The present disclosure has the following beneficial effects:

The examples of the present disclosure provide a method for screening tobacco resistance against root-knot nematode based on intensive seedling production. The method has two biological properties: inducing and stimulating the hatching of nematode eggs with host root exudation, and easily infecting the root cap elongation zone with hatched second-instar larvae. Under the stimulation of constant temperature, breathable substrate, and host tobacco root exudation, the root-knot nematode eggs continue to hatch in the water film on the surface of young roots to produce the second-instar larvae. The second-instar larvae continuously infect fibrous roots. Then, moist cultivation in shallow water creates suitable temperature, humidity and ventilation conditions to induce disease. The disease index is calculated after disease investigation, and the resistance of tested tobacco is evaluated according to the disease index, avoiding the influence of changes in environmental conditions on identification results and improving the accuracy and reproducibility of tobacco root-knot nematode resistance identification. The method can effectively shorten the whole identification cycle with easy operation and high selection efficiency, and can be carried out in batches without interruption or partial overlap, improving the timeliness and scale of tobacco root-knot nematode resistance identification.

### BRIEF DESCRIPTION OF THE DRAWINGS

To illustrate the technical solutions of the present disclosure more clearly, the accompanying drawings need to be used the examples will be briefly described below. It should be understood that the following drawings illustrates only certain examples of the present disclosure, and therefore should not be deemed as limiting the scope of the present disclosure. A person of ordinary skilled in the art may still derive other related drawings from these accompanying drawings without creative efforts.

FIG. 1 is a schematic diagram of tobacco seedlings with 3-4 true leaves aged 20-25 days bred in the first float tray (325 holes) provided in Example 1 of the present disclosure;

FIG. 2 is a schematic diagram of tobacco seedlings with fibrous roots cultivating with shallow water infiltrating and humidifying substrate in the second float tray (32 holes) provided in Example 1 of the present disclosure;

FIG. 3 provides an operation schematic diagram of inoculation nematode eggs into the fibrous roots, and the root exudation and egg inoculation fluid forming water film in Example 1 of the present disclosure;

FIG. 4 provides a schematic diagram of the infected tobacco seedlings cultivated in shallow water infiltrating and humidifying substrate to induce disease in Example 1 of the present disclosure;

FIGS. 5A-5B illustrate root disease symptoms of Nicotiana tabacum cv. NC95 at the 40th day after inoculation provided in Example 1 of the present disclosure, where FIG. 5A shows diseased roots with a small quantity of substrate, and FIG. 5B shows diseased roots when the substrate has been cleaned;

FIGS. 6A-6B illustrate root disease symptoms of Nicotiana tabacum cv. Changbohuang at the 40th day after inoculation provided in Example 1 of the present disclosure, where FIG. 6A shows diseased roots with a small quantity of substrate, and FIG. 6B shows diseased roots when the substrate has been cleaned; and

FIGS. 7A-7B illustrate root disease symptoms of Nicotiana tabacum cv. K326 at the 40th day after inoculation provided in Example 1 of the present disclosure, where FIG. 7A shows diseased roots with a small quantity of substrate, and FIG. 7B shows diseased roots when the substrate has been washed.

### DETAILED DESCRIPTION OF THE EMBODIMENTS

To make the objective, technical solutions, and advantages of the examples of the present disclosure clearer, the technical solutions in the examples of the present disclosure will be described clearly and completely below. If no specific conditions are specified in the examples, the examples will be implemented under conventional conditions or the conditions recommended by the manufacturer. If the reagents or instruments used do not indicate the manufacturer, they are all conventional products that can be commercially available.

A method for screening tobacco resistance against root-knot nematode based on intensive seedling production in the examples of the present disclosure will be described in detail below.

A method for screening tobacco resistance against root-knot nematode based on intensive seedling production is provided, including the steps of:
Step S1, seeds of test tobacco are sowed and performed seedling cultivation in a float system until fibrous roots penetrate out of the float tray into the float pool to obtain fibrous root seedlings;
Step S2, the seedlings with substrate from the float tray are taken out, and transplanted to a larger hole floating tray, the root-knot nematode egg suspension is dropped onto the fibrous roots penetrating surface, and the distal parts of the fibrous roots are immersed into water, and the root-knot nematode eggs in the water film on the surface of the fibrous roots are hatched to produce second-instar larvae; and
Step S3, the infected tobacco plants are cultivated in shallow water infiltrating and humidifying substrate; the disease is induced with simulating the most suitable climatic environment for the root-knot nematode, and the disease severity is evaluated.

The method has two biological properties: inducing and stimulating the hatching of nematode eggs with host root exudation, and easily infecting the root cap elongation zone with hatched second-instar larvae. Under the stimulation of constant temperature, breathable substrate, and host tobacco root exudation, the root-knot nematode eggs continue to hatch in the water film on the surface of young roots to produce the second-instar larvae. The second-instar larvae continuously infect fibrous roots. Then, moist cultivation in shallow water creates suitable temperature, humidity and ventilation conditions to induce disease. The disease index is calculated after disease investigation, and the resistance of tested tobacco is evaluated according to the disease index, avoiding the influences of changes in environmental conditions on identification results and improving the accuracy and reproducibility of tobacco root-knot nematode resistance identification. The method can effectively shorten the whole identification cycle with easy operation and high selection efficiency, and can be carried out in batches without interruption or partial overlap, improving the timeliness and scale of tobacco root-knot nematode resistance identification.

Furthermore, the root-knot nematode egg suspension has a concentration of 500-1,000 eggs/mL, and 1-2 mL of egg suspension is dropped into each tobacco fibrous root seedling. In the above concentration range, it is facilitated that the root-knot nematode eggs are hatched rapidly, and a better infection effect is achieved.

Optionally, a distance between the bottom of the float tray and the water surface is kept at 1-4 cm, so that the distal part of the fibrous roots is immersed in the water. Under this operation, the air permeability of the roots can be maintained, so that the root-knot nematode eggs can be hatched better. In detail, a 3-5 cm long support column can be arranged at the bottom of the float tray, and then the float tray is placed in a 5-8 cm deep shallow tray, while maintaining a water level at 1-2 cm in the shallow tray.

Optionally, the hatching conditions of the root-knot nematode eggs are at 20-30° C. for 3-5 days. In the hatching process, the root-knot nematode eggs may be hatched rapidly under the stimulation of constant temperature and humidity, air permeability, and host tobacco root exudates. Constant humidity is maintained with stalely moist incubator or ultrasonic humidification.

Furthermore, when the seeds of the test tobacco cultivars are induced in a float system, two-stage seedling production in the float system is adopted, including the following steps:
The seeds of the test tobacco cultivars are sowed in the first float tray, and the seedlings are raised for 20-25 days until 3-4 true leaves grow; and
Regular and consistent seedlings containing the substrate are selected from each cultivar, and transplanted into a substrate-free second float tray together with the substrate for 1 plant per hole, and seedlings in the float system are moisturized for 5-7 days until fibrous roots just penetrate out of the second float tray into the float pool in order to obtain the tobacco seedlings with fibrous roots.

Of those mentioned above, the substrate in the first float tray is the commercial tobacco seedling substrate. When cultivated in this substrate, the taproots and lateral roots of tobacco seedlings are not obvious, forming the fibrous roots. About 80% of the substrate can be taken out when more than 80% of tobacco seedlings at the large cross-shaped stage are pulled out. When the two-stage seedling production in the float system is used to identify the resistance against root-knot nematode, the labor intensity of digging and washing roots is significantly reduced. It is only necessary to pull out tobacco roots and washing away a small quantity of substrate from the roots. The two-stage seedling production in the float system has the advantages of simple operation, high space utilization rate, high selection efficiency, and accurate identification of tobacco root-knot nematode resistant phenotype.

In addition, during the moist cultivation in shallow water, the water-soluble fertilizer for seedling-production is applied every 7-10 days, and N:P₂O₅:K₂O in the water-soluble fertilizer for seedling-production are in a mass ratio of (15-20):(8-12):(10-15). The above fertilizer can better promote the growth of infected tobacco plants and shorten the identification cycle.

The water-soluble seedling-production fertilizer has a concentration of 2.5-6.5%. N. And the concentration increases successively with the infected tobacco plants growing. When using the water-soluble fertilizer for seedling-production, the water-soluble fertilizer is first added into water, adjusting to a desired concentration, and then the dissolved fertilizer solution is poured into the shallow tray. The water level of the shallow tray is 3-4 cm at most at this time.

During cultivation in shallow water infiltrating and humidifying substrate, the temperature is maintained at 20-30° C., and the most suitable climatic environment for the root-knot nematode is simulated with dry-wet alternation to induce and form the root-knot.

Further, after 40-50 days of cultivation in shallow water infiltrating and humidifying substrate, the disease severity of the infected tobacco plants is evaluated, and the disease index of the infected tobacco plants is calculated;

The disease severity of the infected tobacco plants is graded as follows:
Grade 0: normal roots;
Grade 1: no more than ¼ of roots with a small quantity of root knots;
Grade 3: ¼-⅓ of roots with a small quantity of root knots;
Grade 5: ⅓-½ of roots with root knots;
Grade 7: no less than ½ of roots with root knots, and a few secondary roots with root knots; and
Grade 9: all roots (including the secondary roots) full of root knots.

The disease index is calculated using the following formula:

$$Disease index = {\sum }_{i = 0}^{9} ( i \times {x}_{i} ) / ( {\sum }_{i = 0}^{9} {x}_{i} \times 9 ) \times 100$$

Where i is the disease severity (grades 0 to 9); and xᵢ is the number of grade i plants.

In addition, resistance grades of the tobacco cultivars are evaluated according to the disease index, and the resistance grades are divided according to the following criteria:
Immunity (I): the disease index is 0;
Resistance (R): the disease index is 0.1-20.0;
Moderate resistance (MR): the disease index is 20.1-40.0;
Moderate susceptibility (MS): the disease index is 40.1-60.0;
Susceptibility(S): the disease index is 60.1-80.0; and
High susceptibility (HS): the disease index is 80.1-100.0.

Further, in order to improve the accuracy of the test, it is necessary to get the disease severity 5 plants of each tobacco cultivar at least, that is to say, 5 plants for 1 replicate, at least 3 replicates for each cultivar, and randomly distributed in the second float tray for the replicates of each cultivar.

The features and performance of the present disclosure will be further described in detail below with reference to the examples.

### Example 1

The present example provided a method for screening tobacco resistance against root-knot nematode based on intensive seedling production. The tobacco cultivars used in this example included Nicotiana tabacum cv. NC95, Nicotiana tabacum cv. Changbohuang, and Nicotiana tabacum cv. K326. Meloidogyne incongnita was propagated in vivo by susceptible tomato Rutgers. The tomato root with nematode egg mass was cut short and put to sodium hypochlorite solution. Stirring solution, the nematode eggs fell off the egg mass in the root node and entered the solution. Centrifuging the solution, suspending, and washing, repeating multiple times, the obtained nematode eggs were suspended in water, forming the egg suspension, adjusting to a desired concentration, and used as an inoculation suspension.

The specific operation steps were as follows:

### Step S1. Cultivation of Tobacco Fibrous Root Seedlings

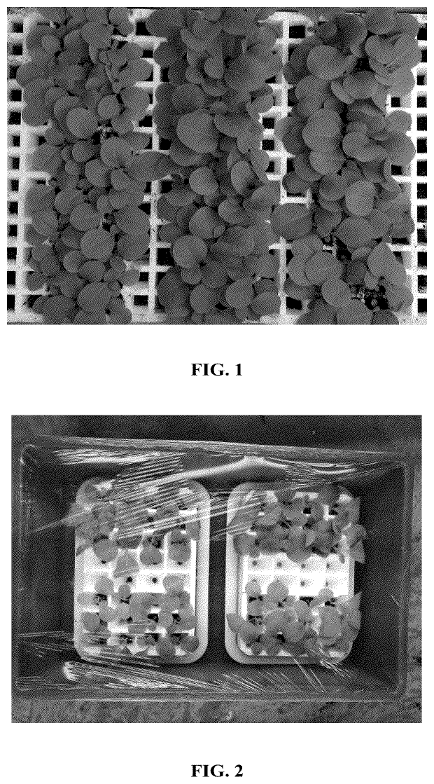

The seeds of 3 tobacco cultivars, NC95, Changbohuang, and K326, were sown in the first float tray (325 holes), and the seedlings were raised for 20-25 days until 3-4 true leaves stage (FIG. 1). Regular and consistent seedlings with the substrate were selected from each cultivar and transplanted into the second float tray (32 holes) with no substrate, 1 plant per hole. The seedlings in the float system were moisturized for 5-7 days until fibrous roots just penetrated out of the second float tray into the float pool to obtain tobacco fibrous root seedlings (FIG. 2). 12 plants of each cultivar were used as 1 replicate, with 4 replicates for each cultivar and randomly distributed in the second float tray (32 holes) for each replicate.

### Step S2. Hatching and Inoculation of Nematode Eggs in the Root Exudate Water Film

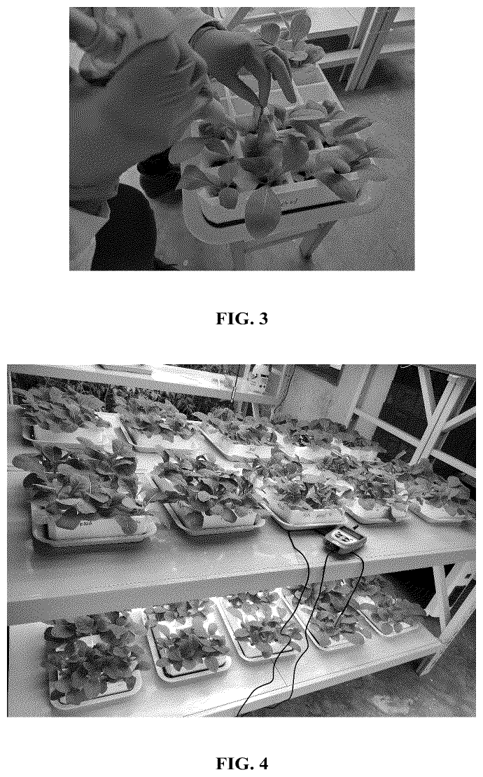

The 3-5 cm long supporting column was inserted at the bottom 4 corners of the float tray of the tobacco fibrous root seedlings. The float tray was lifted and placed in the 5-8 cm deep completed set shallow tray, and 1 mL each of 500-600 eggs/mL root-knot nematode egg suspension was dropped to 4 root penetrating surfaces of each plant (FIG. 3). The water level of the shallow tray was maintained at 1-2 cm to keep the roots breathable, and the shallow tray was moisturized in a humidistat. Thus, the root-knot nematode eggs were kept in a breathable environment at a constant temperature of 20-30° C. and continuously hatched to produce second-instar larvae that infected the young roots inside and outside the substrate. The inoculation was completed, and an artificial disease nursery was formed.

### Step S3. The Infected Seedlings Cultivating in Shallow Water Infiltrating and Humidifying Substrate to Induce Disease

The infected tobacco seedlings were cultivated in shallow water infiltrating and humidifying substrate to induce disease (FIG. 4). The water-soluble fertilizer for seedling-production in an N:P₂O₅:K₂O ratio of (15-20):(8-12):(10-15) was applied once every 7-10 days, and the concentration was 2.5-6.5% % N. The concentration increased successively with the increase of seedling age. The water-soluble fertilizer is first added into water, adjusting to a desired concentration, and then the dissolved fertilizer solution is poured into the shallow tray. The water level of the shallow tray was 3-4 cm at most. At a constant temperature of 20-30° C., the most suitable climatic environment for root-knot nematode was simulated with dry-wet alternation to induce and form the root-knot.

### Step S4. Resistance Evaluation

Disease investigation was performed on the 40th day after inoculation. All tobacco plants were investigated for the disease index calculated based on the disease severity, and resistance was evaluated according to the disease index. The results are shown in Table 1.

TABLE 1
Identification results of different tobacco cultivars resistance against M. incongnita

| | | Number of | | | | | | | | Average | |
|---|---|---|---|---|---|---|---|---|---|---|---|
| Cultivar | The number | investigated | Number of diseased plants of each grade | | | | | | Disease | disease | Resistance |
| name | of repetition | plants | 0 | 1 | 3 | 5 | 7 | 9 | index | index | evaluation |
| NC95 | I | 12 | 0 | 8 | 4 | 0 | 0 | 0 | 18.52 | 18.98 | Resistance |
| | II | 12 | 0 | 7 | 5 | 0 | 0 | 0 | 20.37 | | (R) |
| | III | 12 | 0 | 9 | 3 | 0 | 0 | 0 | 16.67 | | |
| | IV | 12 | 0 | 7 | 5 | 0 | 0 | 0 | 20.37 | | |
| Changbohuang | I | 12 | 0 | 0 | 1 | 6 | 4 | 1 | 64.81 | 64.98 | Susceptibility |
| | II | 11 | 0 | 0 | 1 | 6 | 3 | 1 | 63.64 | | (S) |
| | III | 12 | 0 | 0 | 0 | 6 | 5 | 1 | 68.52 | | |
| | IV | 12 | 0 | 0 | 2 | 5 | 4 | 1 | 62.96 | | |
| K326 | I | 12 | 0 | 0 | 8 | 3 | 1 | 0 | 42.59 | 37.96 | Moderate |
| | II | 12 | 0 | 4 | 5 | 2 | 1 | 0 | 33.33 | | resistance |
| | III | 12 | 0 | 3 | 5 | 2 | 2 | 0 | 38.89 | | (MR) |
| | IV | 12 | 0 | 3 | 5 | 3 | 1 | 0 | 37.04 | | |

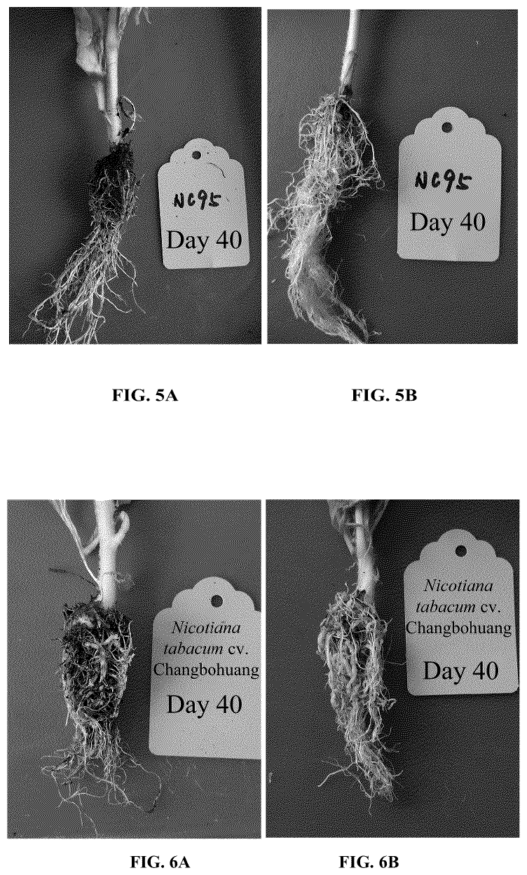

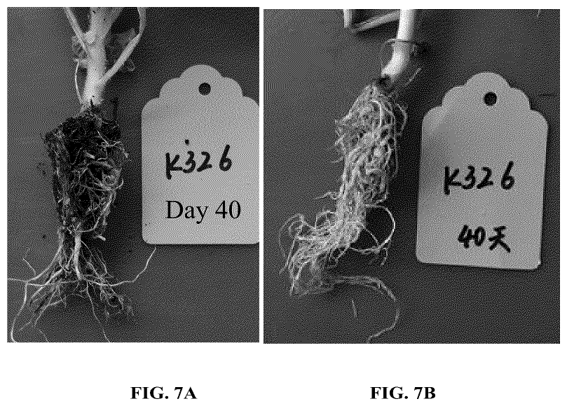

From Table 1, the occurrence of root knots of various tobacco cultivars was investigated on the 40th day after inoculation of M. incongnita eggs, and it was found that different cultivars showed a significant difference between each other in the severity of root knots (FIGS. 5A-5B, FIGS. 6A-6B, and FIGS. 7A-7B). The results showed that there were significant differences in resistance against M. incongnita among 3 tested tobacco cultivars. Among them, the average disease index of NC95 was 18.98, showing resistance (R); that of Changbohuang was 64.98, showing susceptibility(S); and that of K326 was 37.96, showing moderate resistance (MR). The identification results of these cultivars were completely consistent with those reported in the literature, indicating that the method was stable and reliable, and could be used to identify the resistance of tobacco cultivars to root-knot nematode.

### Example 2

The present example provided a method for screening tobacco resistance against root-knot nematode based on intensive seedling production. There were 34 tobacco cultivars used in this example, as shown in Table 2. Meloidogyne incongnita was propagated in vivo by susceptible tomato Rutgers. The tomato root with nematode egg mass was cut short and put to sodium hypochlorite solution. Stirring solution, the nematode eggs fell off the egg mass in the root node and entered the solution. Centrifuging the solution, suspending and washing, repeating multiple times, the obtained nematode eggs were suspended in water, forming the egg suspension, adjusting to a desired concentration, used as an inoculation suspension.

The specific operation steps were as follows:

### Step S1. Cultivation of Tobacco Fibrous Root Seedlings

The seeds of 34 test tobacco cultivars were sown in the first float tray (325 holes), and the seedlings were raised for 20-25 days until 3-4 true leaves stage. Regular and consistent seedlings with the substrate were selected from each cultivar and transplanted into the second float tray (32 holes) with no substrate, 1 plant per hole. The seedlings in the float system were moisturized for 5-7 days until fibrous roots just penetrated out of the second float tray into the float pool to obtain tobacco seedlings with fibrous roots. 12 plants of each cultivar were used as 1 replicate, 4 replicates for each cultivar and randomly distributed in the second float tray (32 holes) for each replicate.

### Step S2. Hatching and Inoculation of Nematode Eggs in the Root Exudate Water Film

The 3-5 cm long supporting column was inserted at the bottom 4 corners of the float tray of the tobacco fibrous root seedlings. The float tray was lifted and placed in the 5-8 cm deep completed set shallow tray, and 1 mL each of 600-800 eggs/mL root-knot nematode egg suspension was dropped to 4 root penetrating surfaces of each plant. The water level of the shallow tray was maintained at 1-2 cm to keep the roots breathable, and the shallow tray was moisturized in a humidistat. Thus, the root-knot nematode eggs were kept in a breathable environment at a constant temperature of 20-30° C. and continuously hatched to produce second-instar larvae in the water film on the surface of the young roots for 3-5 days under the stimulation of the host tobacco root exudates, of which the second-instar larvae infected the young roots inside and outside substrate. The inoculation was completed, and an artificial disease nursery was formed.

### Step S3. The Infected Seedlings Cultivating in Shallow Water Infiltrating and Humidifying Substrate to Induce Disease

The infected tobacco seedlings were cultivated in shallow water infiltrating and humidifying substrate to induce disease. The water-soluble seedling-production fertilizer in an N:P₂O₅:K₂O ratio of 18:10:13 was applied once every 7-10 days, and the concentration was 2.5-6.5% % N. The concentration increased successively with the increase of seedling age. water-soluble fertilizer is first added into water, adjusting to a desired concentration and then the dissolved fertilizer solution is poured into the shallow tray. The water level of the shallow tray was 3-4 cm at most. At a constant temperature of 20-30° C., the most suitable climatic environment for root-knot nematode was simulated with dry-wet alternation to induce and form the root-knot.

### Step S4. Resistance Evaluation

Disease investigation was performed on the 40th day after inoculation. All tobacco plants were investigated for the disease index calculated based on the disease severity, and resistance was evaluated according to the disease index.

### Step S5. Contrast Test

The seeds of 34 test tobacco cultivars were sown in the first float tray (325 holes), and the seedlings were raised for 20-25 days until 3-4 true leaves stage. Regular and consistent seedlings with the substrate were selected from each cultivar and transplanted into the pots (18 cmx 21 cm) filled with pot soil. A small pit was dug in the middle of the pot and the M. incongnita egg suspension (3,000-5,000 eggs/plant) was evenly sprinkled into the pit soil, stirring the pit soil, and transplanting tobacco seedlings. 6 plants of each cultivar were used as 1 replicate, 1 plant in each pot, and 3 replicates for each cultivar. The potted plants were managed according to the conventional method, and the disease investigation and resistance identification were carried out. The identification results are shown in Table 2.

TABLE 2
Comparison of 34 test tobacco cultivars
resistance against M. incongnita

| | | Present disclosure | | Conventional potting | |
|---|---|---|---|---|---|
| | | Disease | Resistance | Disease | Resistance |
| No. | Cultivar name | index | evaluation | index | evaluation |
| 1 | HB094 | 43.06 | MS | 55.56 | MS |
| 2 | LY338 | 54.07 | MS | 50.00 | MS |
| 3 | YY021 | 38.46 | MR | 39.68 | MR |
| 4 | HB0901 | 50.00 | MS | 58.73 | MS |
| 5 | LY2804 | 36.75 | MR | 33.33 | MR |
| 6 | CF239 | 25.25 | MR | 30.56 | MR |
| 7 | NC89 | 24.79 | MR | 25.00 | MR |
| 8 | YN222 | 65.78 | S | 72.22 | S |
| 9 | GZ42 | 62.96 | S | 61.11 | S |
| 10 | SC852 | 39.26 | MR | 38.89 | MR |
| 11 | CF237 | 51.39 | MS | 52.78 | MS |
| 12 | S294 | 52.59 | MS | 50.00 | MS |
| 13 | YN224 | 16.67 | R | 18.22 | R |
| 14 | QGZ45 | 59.72 | MS | 55.56 | MS |
| 15 | K326 | 51.11 | MS | 42.86 | MS |
| 16 | Yunyan 87 | 57.04 | MS | 47.22 | MS |
| 17 | NX212 | 31.31 | MR | 30.56 | MR |
| 18 | FL1991 | 48.15 | MS | 48.15 | MS |
| 19 | HC1702 | 45.83 | MS | 41.67 | MS |
| 20 | QYCH01 | 37.37 | MR | 36.11 | MR |
| 21 | GZ37 | 34.92 | MR | 38.89 | MR |
| 22 | GZ41 | 42.22 | MS | 41.67 | MS |
| 23 | SC20 | 61.56 | S | 65.90 | S |
| 24 | GZ43 | 50.79 | MS | 46.03 | MS |
| 25 | Gexin 3 | 26.98 | MR | 30.56 | MR |
| 26 | Xiaohuangjin 1025 | 47.22 | MS | 47.22 | MS |
| 27 | Jinxing 6007 | 34.72 | MR | 38.89 | MR |
| 28 | Beinhart1000-1 | 27.78 | MR | 36.51 | MR |
| 29 | Hongda | 63.89 | S | 77.78 | S |
| 30 | Florida 301 | 62.38 | S | 71.90 | S |
| 31 | G140 | 33.33 | MR | 27.78 | MR |
| 32 | Samsun-NN | 60.00 | MS | 50.00 | MS |
| 33 | Changbohuang | 68.63 | S | 79.67 | S |
| 34 | NC95 | 19.08 | R | 19.22 | R |

According to the results of disease statistics and resistance evaluation for each cultivar in Table 2, the present disclosure was basically consistent with the pot resistance identification. Even if there was a difference in the disease index, the resistance/susceptibility level was completely consistent. Of the 34 tobacco cultivars, 2 cultivars were resistant (R), 12 were moderately resistant (MR), 14 were moderately susceptible (MS), and 6 were susceptible(S). Again, the results verified that the identification method of the present disclosure could be used to identify the resistance against root-knot nematode of tobacco cultivars. Compared with the conventional identification, it showed that the space occupied by the 4 materials in the present disclosure was equivalent to 1 potted material, that the workload of digging and washing roots was reduced by ½ to ⅔, and that the identification period was shortened by 10-20 days, which was more suitable for large-scale identification.

In conclusion, the examples of the present disclosure provided a method for screening tobacco resistance against root-knot nematode based on intensive seedling production. The method had two biological properties: host root exudates induce and stimulate the hatching of nematode eggs, and hatched second-instar larvae are easy to infect the root cap elongation zone. Second-instar larvae e hatched by the root-knot nematode eggs are continuously inoculated. Under the stimulation of constant temperature, breathability, and host tobacco root exudates, root-knot nematode eggs continue to hatch in the water film on the surface of young roots to produce the second-instar larvae. After that, under cultivated in shallow water infiltrating and humidifying substrate, suitable temperature and humidity and air permeability conditions are created for disease induction. After disease investigation, the disease index is calculated, and the resistance of tested cultivars is evaluated according to the disease index, avoiding the influence of changes in environmental conditions on identification results and improving the accuracy and reproducibility of tobacco root-knot nematode resistance identification. With easy operation and high selection efficiency, the method can effectively shorten the whole identification cycle, and can be carried out in batches without interruption or partial overlap, improving the timeliness and scale of tobacco root-knot nematode resistance identification.

The above are only preferred embodiments of the present disclosure and are not intended to limit the present disclosure. The present disclosure may have various modifications and variations to those skilled in the arts Any modification, equivalent substitution, and improvement made within the spirit and principle of the present disclosure shall fall within the protection scope of the present disclosure.

What is claimed is:

1. A method for screening tobacco resistance against root-knot nematode based on intensive seedling production, comprising steps of:
sowing test tobacco seeds and performing seedling cultivation in a float system until fibrous roots penetrate out of a float tray into a float pool to obtain fibrous root seedlings;
taking out the fibrous root seedlings with a substrate from the float tray and transplanting the fibrous root seedlings to a larger hole float tray without the substrate, dropping a suspension of root-knot nematode eggs onto a fibrous roots protruding substrate surface, then immersing distal parts of the fibrous roots into water and hatching the root-knot nematode eggs in a water film on a surface of the fibrous roots to produce second-instar larvae; and
cultivating infected tobacco seedlings in shallow water infiltrating and humidifying the substrate, inducing a disease by simulating a most suitable climatic environment for the root-knot nematode, and evaluating a disease severity.

2. The method for screening the tobacco resistance against the root-knot nematode based on the intensive seedling production according to claim 1, wherein the suspension of the root-knot nematode eggs has a concentration of 500-1,000 eggs/mL, and a drop to each tobacco fibrous root seedling is 1-2 mL.

3. The method for screening the tobacco resistance against the root-knot nematode based on the intensive seedling production according to claim 1, wherein a distance between a bottom of the float tray and a water surface is kept at 1-4 cm, and the distal parts of the fibrous roots are immersed in water.

4. The method for screening the tobacco resistance against the root-knot nematode based on the intensive seedling production according to claim 2, wherein the root-knot nematode eggs are hatched for 3-5 days at 20-30° C.

5. The method for screening the tobacco resistance against the root-knot nematode based on the intensive seedling production according to claim 1, wherein the test tobacco seeds are induced in the float system, and two-stage seedling production in the float system is adopted, comprising the following steps:
sowing the test tobacco seeds in a first float tray, and production seedlings for 20-25 days until 3-4 true leaves grow; and
selecting regular and consistent seedlings from each test tobacco seed to transplant seedlings together with the substrate into a substrate-free second float tray by 1 plant per hole, moisturizing the regular and consistent seedlings in the float system for 5-7 days until the fibrous roots penetrate out of the substrate-free second float tray into the float pool to obtain tobacco seedlings with the fibrous roots.

6. The method for screening the tobacco resistance against the root-knot nematode based on the intensive seedling production according to claim 1, wherein a water-soluble fertilizer for the intensive seedling production is applied every 7-10 days during cultivating the infected tobacco seedlings in the shallow water infiltrating and humidifying the substrate, and N:P₂O₅:K₂O in the water-soluble fertilizer for the intensive seedling production is (15-20):(8-12):(10-15).

7. The method for screening the tobacco resistance against the root-knot nematode based on the intensive seedling production according to claim 6, wherein the water-soluble fertilizer for the intensive seedling production has 2.5-6.5% % N.

8. The method for screening the tobacco resistance against the root-knot nematode based on the intensive seedling production according to claim 7, wherein a temperature is maintained at 20-30° C. during cultivating the infected tobacco seedlings in the shallow water infiltrating and humidifying the substrate, and the most suitable climatic environment for the root-knot nematode is simulated with a dry-wet alternation to induce and form the root-knot nematode.

9. The method for screening the tobacco resistance against the root-knot nematode based on the intensive seedling production according to claim 1, wherein the disease severity of infected tobacco plants is evaluated after 40-50 days of a moist cultivation in the shallow water, and a disease index of the infected tobacco plants is calculated;
the disease severity of the infected tobacco plants is graded as follows: grade 0: normal roots; grade 1: no more than ¼ of roots with a quantity of root knots; grade 3: ¼-⅓ of roots with a quantity of root knots; grade 5: ⅓-½ of roots with root knots; grade 7: no less than ½ of roots with root knots, and a few secondary roots with root knots; and grade 9: all roots (including the secondary roots) full of root knots;
the disease index is calculated with the following formula:
$$Disease index = {\sum }_{i = 0}^{9} ( i \times {x}_{i} ) / ( {\sum }_{i = 0}^{9} {x}_{i} \times 9 ) \times 100$$
wherein i is the disease severity comprising grades 0 to 9; and xᵢ is a number of grade i plants.

10. The method for screening the tobacco resistance against the root-knot nematode based on the intensive seedling production according to claim 9, wherein resistance grades of tobacco cultivars are evaluated according to the disease index, and the resistance grades are divided according to the following criteria:
immunity (I): the disease index is 0; resistance (R): the disease index is 0.1-20.0; moderate resistance (MR): the disease index is 20.1-40.0; moderate susceptibility (MS): the disease index is 40.1-60.0; susceptibility(S): the disease index is 60.1-80.0; and high susceptibility (HS): the disease index is 80.1-100.0.
